(19) United States
(12) Patent Application Publication
(10) Pub. No.: US 2006/0177723 A1
(43) Pub. Date: Aug. 10, 2006

(54) Fuel cell stack

(76) Inventors: Shigeru Inai, Tochigi-ken (JP); Masao Utsunomiya, Utsunomiya-shi (JP); Hiromichi Yoshida, Tochigi-ken (JP); Satoru Terada, Utsunomiya-shi (JP); Ryo Jinba, Utsunomiya-shi (JP); Makoto Tsuji, Saitama-shi (JP); Ichiro Tanaka, Utsunomiya-shi (JP)

Correspondence Address: FISH & RICHARDSON P.C., P.O. BOX 1022, MINNEAPOLIS, MN, 55440-1022, US

(21) Appl. No.: 11/345,837

(22) Filed: Feb. 1, 2006

(30) Foreign Application Priority Data
Feb. 7, 2005 (JP) 2005-30212

(51) Int. Cl. H01M 8/02; H01M 8/24; H01M 8/10

(52) U.S. Cl. 429/34; 429/32

(57) ABSTRACT

A stacked body is formed by stacking a plurality of power generation cells in a stacking direction. End power generation cells are provided at opposite ends of the stacked body in the stacking direction. Each of the power generation cells includes a membrane electrode assembly and first and second metal separators sandwiching the membrane electrode assembly therebetween. The end power generation cells include first outer separators and second outer separators. The first outer separators are more highly hydrophilic in comparison with the first and second metal separators of the power generation cells.

### BACKGROUND OF THE INVENTION

1. Field of the Invention

The present invention relates to a fuel cell stack formed by stacking a plurality of power generation cells. Each of the power generation cells includes an electrolyte electrode assembly and separators sandwiching the electrolyte electrode assembly. The electrolyte electrode assembly includes a pair of electrodes, and an electrolyte interposed between the electrodes.

2. Description of the Related Art

A polymer electrolyte fuel cell employs, for example, a membrane electrode assembly, which includes an anode, a cathode, and an electrolyte membrane (electrolyte) interposed between the anode and the cathode. The electrolyte membrane is a polymer ion exchange membrane. The membrane electrode assembly and separators sandwiching the membrane electrode assembly make up a power generation cell unit for generating electricity. In general, a predetermined number of such power generation cells are stacked together in a stacking direction. Further, terminal plates, insulating plates, and end plates are provided at opposite ends of the power generation cells in the stacking direction, thereby forming a fuel cell stack.

In the fuel cell, a fuel gas, such as a gas chiefly containing hydrogen (hereinafter also referred to as a “hydrogen-containing gas”), is supplied to the anode. Another gas, chiefly containing oxygen or the air (hereinafter also referred to as an “oxygen-containing gas”), is supplied to the cathode. An anode catalyst induces a chemical reaction in the fuel gas, to split hydrogen molecules into hydrogen ions and electrons. The hydrogen ions move toward the cathode through the electrolyte membrane, and the electrons flow through an external circuit to the cathode, thus creating DC electrical energy.

On the downstream side of the oxygen-containing gas flow, water produced during the power generation reaction is likely to be retained. On the upstream side of the oxygen-containing gas flow, water is not retained easily, and the electrolyte membrane may become dried undesirably.

In this regard, for example, a polymer electrolyte fuel cell as disclosed in Japanese Laid-Open Patent Publication No. 2004-146246 is known. As shown in FIG. 8, the fuel cell includes an electrolyte membrane 1, a fuel electrode 2, an oxidant electrode 3, a fuel separator 4, an oxygen-containing gas separator 5, and a water flow plate 6. The fuel separator 4 has a fuel channel 4a for supplying a fuel to the fuel electrode 2. The oxygen-containing gas separator 5 has an oxygen-containing gas channel 5a for supplying an oxygen-containing gas to the oxidant electrode 3. The water flow plate 6 has a water passageway 6a.

The oxygen-containing gas separator 5 includes fine pores therein. An upstream area 7a of the oxygen-containing gas separator 5 faces the oxygen-containing gas channel 5a, when viewed in cross section along a thickness dimension of the gas separator 5. The upstream area 7a includes a hydrophobic area X2 and a hydrophilic area X1. The hydrophobic area X2 is more highly hydrophobic in comparison with a downstream area 7b. The hydrophilic area X1 is provided oppositely to the hydrophobic area X2 on the side closer to the water passageway 6a.

In this structure, in the downstream area 7b, water that has passed through the hydrophilic area X1 facing the water passageway 6a is vaporized within the hydrophobic area X2. The vaporized water is utilized to humidify the oxygen-containing gas in the oxygen-containing gas channel 5a.

In some of the power generation cells of the fuel cell stack, in comparison with other power generation cells thereof, temperature is decreased easily due to heat radiation to the outside. For example, in the power generation cells provided at ends of the fuel cell stack in the stacking direction (hereinafter also referred to as “end power generation cells”), large amounts of heat are radiated externally from the terminal plates (current collecting plates) for collecting electrical charges generated in each of the power generation cells as electricity, as well as from the end plates for tightening the stacked power generation cells, wherein the decrease in temperature is significant.

Therefore, due to the decrease in temperature in the end power generation cells, water condensation occurs easily in comparison with power generation cells located centrally in the fuel cell stack, and water produced during power generation cannot be discharged smoothly. As a result, the reactant gases do not flow smoothly therein, and voltage differences may occur between the power generation cells. When unstable power generation cells having decreased voltage exist, control of the fuel cell stack must be implemented taking into account the presence of such unstable power generation cells. As a result, a purge control must be additionally implemented, and the amount of reactant gas supplied to the fuel cell stack must be increased. As a result, the power generation efficiency of the fuel cell stack is lowered.

### SUMMARY OF THE INVENTION

A main object of the present invention is to provide a fuel cell stack in which the flow rate of reactant gas supplied to the end power generation cells is equal to the flow rate of the reactant gas supplied to other power generation cells, wherein an improvement in power generation efficiency is achieved.

According to the present invention, a fuel cell stack is formed by stacking a plurality of power generation cells in a stacking direction. Each of the power generation cells includes an electrolyte electrode assembly and separators sandwiching the electrolyte electrode assembly. The electrolyte electrode assembly includes a pair of electrodes, with an electrolyte interposed between the electrodes. The fuel cell stack further comprises end,power generation cells, which are provided at opposite ends of the power generation cells in the stacking direction. Outer separators of the end power generation cells are made more highly hydrophilic in comparison at least with inner separators of power generation cells arranged inwardly of the end power generation cells.

Further, preferably the contact angle of water in the outer separators is smaller than the contact angle of water in the inner separators. Preferably, the outer separators include a first outer separator provided at one end in the stacking direction, and a second outer separator provided inwardly thereof in the stacking direction, wherein the first outer separator is more hydrophilic than the second outer separator. Further, preferably, the contact angle of water in the outer separators is 90° or less.

According to the present invention, since the outer separators are highly hydrophilic, drainage of water therein is improved. Water condensed due to decreases in temperature in the end power generation cells can be discharged easily. Further, since such condensed water is spread over the surface of the outer separator, the reactant gas flow field does not become easily closed, and thus, the reactant gas flows smoothly. With a simple and economical structure, the flow rate of reactant gas flowing through the end power generation cells can be made equal to the flow rate of reactant gas flowing through the other power generation cells. Thus, it is possible to reliably improve overall power generation efficiency of the fuel cell stack.

If a water repellent treatment is effected on the outer separator, water droplets may be caused on the surface of the outer separator. Such water droplets have a spherical shape, a columnar shape, or a membrane shape on the surface of the outer separator. Therefore, the reactant gas flow fields may be closed by such water droplets. In order to solve this problem, by applying a hydrophilic treatment to the outer separator, an improvement in power generation efficiency is achieved. In this process, conventional hydrophilic treatments can be adopted. For example, the technique disclosed in Japanese Laid-Open Patent Publication No. 2004-146246 can be used.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a fuel cell stack according to an embodiment of the present invention;

FIG. 2 is a side view, in partial cutaway, showing the fuel cell stack;

FIG. 3 is an exploded perspective view showing a power generation cell of the fuel cell stack;

FIG. 4 is a view showing a case where the contact angle is 90° or less;

FIG. 5 is a view showing a case where the contact angle is greater than 90°;

FIG. 6 is a graph showing the internal temperature of a central power generation cell and the internal temperature of an end power generation cell;

FIG. 7 is a graph showing a relationship between end cell voltage and time, depending on whether a hydrophilic treatment is applied or not; and

FIG. 8 is a cross sectional view showing a conventional polymer electrolyte fuel cell.

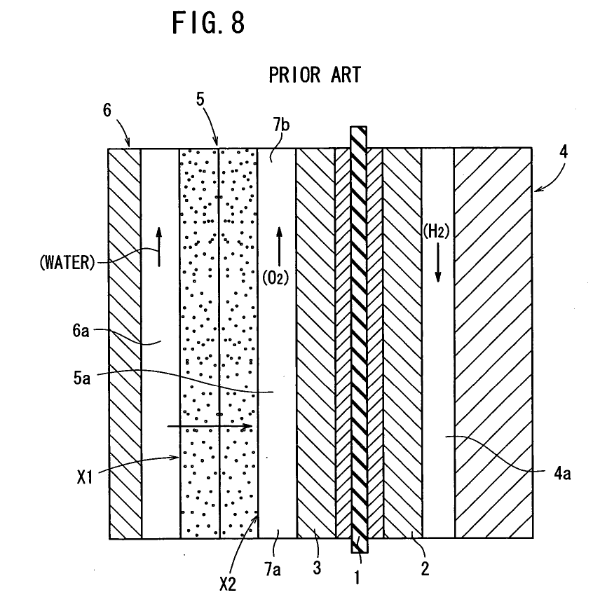

### DESCRIPTION OF THE PREFERRED EMBODIMENTS

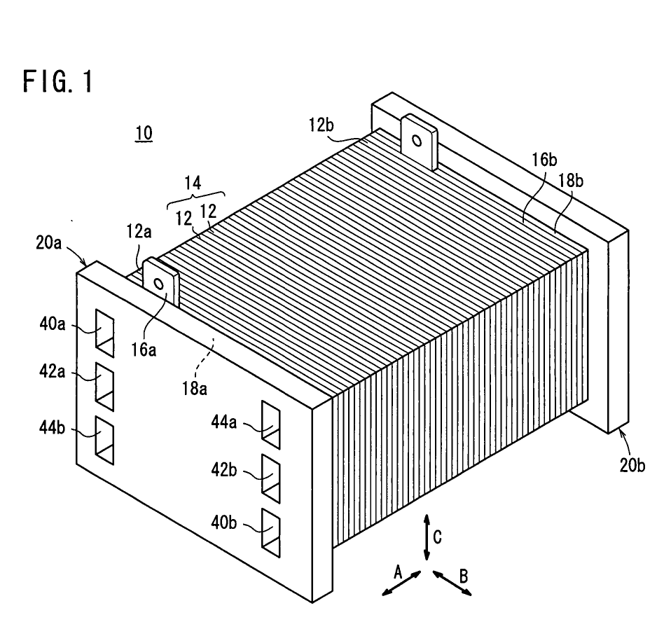

FIG. 1 is a perspective view showing a fuel cell stack 10 according to an embodiment of the present invention.

The fuel cell stack 10 includes a stacked body 14 formed by stacking a plurality of power generation cells 12 in a stacking direction indicated by arrow A. At opposite ends of the stacked body 14 in the stacking direction, end power generation cells 12a, 12b are provided. Terminal plates 16a, 16b are provided outside of the end power generation cells 12a, 12b. Insulating plates 18a, 18b are provided outside of the terminal plates 16a, 16b. Further, end plates 20a, 20b are provided outside of the insulating plates 18a, 18b. Although not shown, the fuel cell stack 10 is tightened, for example, by tightening bolts, or held in a box-shaped casing. The fuel cell stack 10 may be mounted in a vehicle such as an automobile.

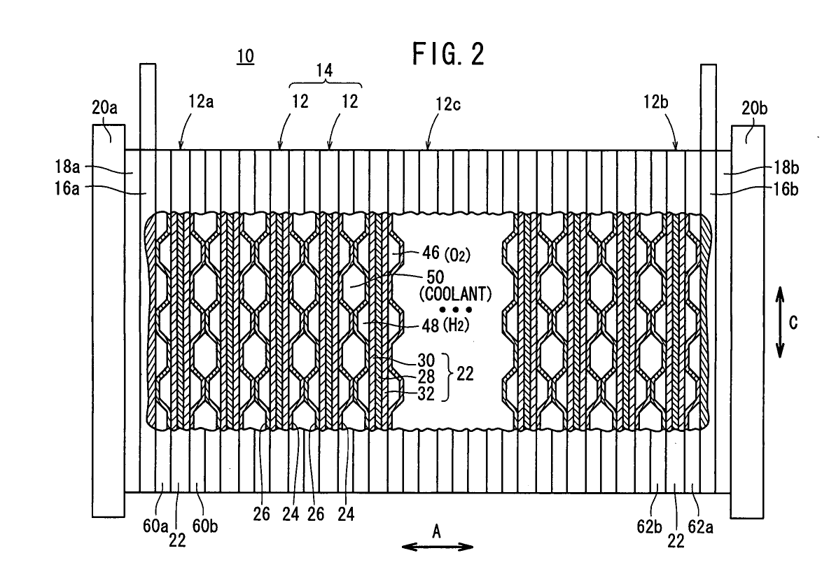

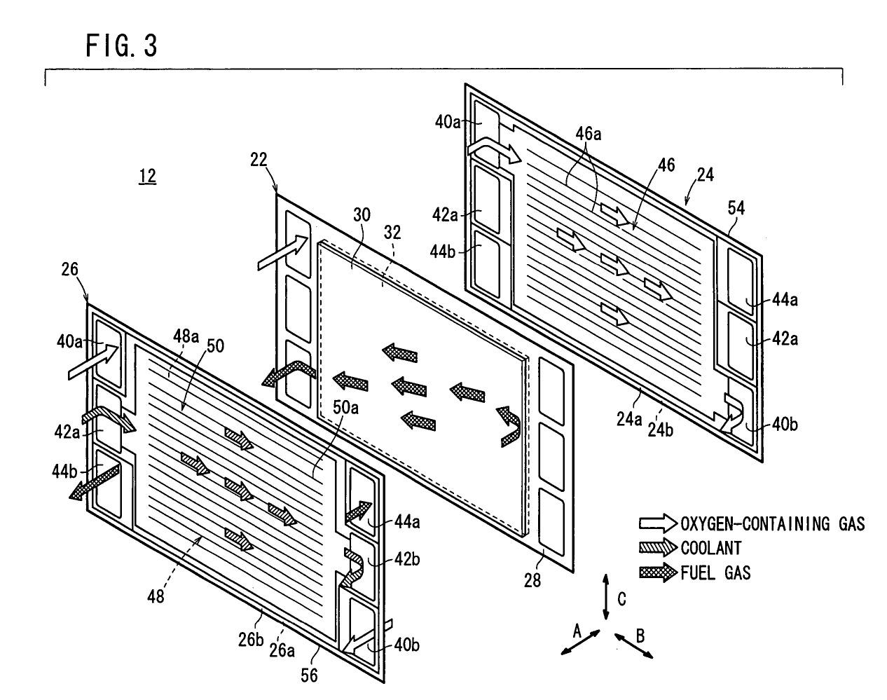

As shown in FIGS. 2 and 3, each of the power generation cells 12 includes an electrolyte membrane electrode assembly (electrolyte electrode assembly) 22 and first and second metal separators (inner separators) 24, 26 stacked in a horizontal direction (direction of the arrow A). Instead of using the first and second metal separators 24, 26, for example, carbon separators may also be used.

The membrane electrode assembly 22 includes an anode 30, a cathode 32, and a solid polymer electrolyte membrane (electrolyte) 28 interposed between the anode 30 and the cathode 32. The solid polymer electrolyte membrane 28 is formed by impregnating a thin membrane of perfluorosulfonic acid with water, for example. Each of the anode 30 and the cathode 32 has a gas diffusion layer (not shown), formed from carbon paper or the like, and an electrode catalyst layer (not shown) formed by a platinum alloy supported on porous carbon particles. The carbon particles are deposited uniformly on the surface of the gas diffusion layer. The electrode catalyst layer of the anode 30 and the electrode catalyst layer of the cathode 32 are fixed to both surfaces of the solid polymer electrolyte membrane 28, respectively.

At one end of the power generation cell 12, in the direction indicated by the arrow B, an oxygen-containing gas supply passage 40a for supplying an oxygen-containing gas, a coolant supply passage 42a for supplying a coolant, and a fuel gas discharge passage 44b for discharging a fuel gas, such as a hydrogen-containing gas, are arranged vertically in the direction indicated by the arrow C. The oxygen-containing gas supply passage 40a, the coolant supply passage 42a, and the fuel gas discharge passage 44b extend through the power generation cell 12 in the stacking direction indicated by the arrow A.

At the other end of the power generation cell 12, in the direction indicated by the arrow B, a fuel gas supply passage 44a for supplying the fuel gas, a coolant discharge passage 42b for discharging the coolant, and an oxygen-containing gas discharge passage 40b for discharging the oxygen-containing gas, are arranged in the direction indicated by the arrow C. The fuel gas supply passage 44a, the coolant discharge passage 42b, and the oxygen-containing gas discharge passage 40b extend through the power generation cell 12 in the direction indicated by the arrow A.

The first metal separator 24 has an oxygen-containing gas flow field 46 on a surface 24a thereof facing the membrane electrode assembly 22. The oxygen-containing gas flow field 46 comprises a plurality of oxygen-containing gas flow grooves 46a extending in the direction indicated by the arrow B. Alternatively, the oxygen-containing gas flow field 46 may comprise grooves in a serpentine pattern, having three straight regions and two turn regions, for allowing the oxygen-containing gas to flow back and forth in the direction indicated by the arrow B.

The second metal separator 26 has a fuel gas flow field 48 on a surface 26a thereof facing the membrane electrode assembly 22. As with the oxygen-containing gas flow field 46, the fuel gas flow field 48 comprises a plurality of fuel gas flow grooves 48a extending in the direction indicated by the arrow B.

A surface 24b of the first metal separator 24 faces a surface 26b of the second metal separator 26, and a coolant gas flow field 50 is formed between the surfaces 24a and 26b of the first metal separator 24 and the second metal separator 26. That is, the coolant flow field 50 is formed between the back surface of the oxygen-containing gas flow field 46 and the back surface of the fuel gas flow field 48. The coolant flow field 50 includes a plurality of coolant flow grooves 50a extending in the direction indicated by the arrow B. The coolant flow field 50 is connected to the coolant supply passage 42a and the coolant discharge passage 42b.

A first seal member 54 is formed integrally, e.g., by injection molding, on surfaces 24a, 24b of the first metal separator 24 surrounding the outer edge of the first metal separator 24. On the surface 24a, the first seal member 54 is formed so as to surround the oxygen-containing gas supply passage 40a, the oxygen-containing gas discharge passage 40b, and the oxygen-containing gas flow field 46 for preventing leakage of the oxygen-containing gas.

A second seal member 56 is formed integrally, e.g., by injection molding, on surfaces 26a, 26b of the second metal separator 26 surrounding the outer edge of the second metal separator 26. On the surface 26a, the second seal member 56 is formed so as to surround the fuel gas supply passage 44a, the fuel gas discharge passage 44b, and the fuel gas flow field 48 for preventing leakage of the fuel gas. On the surface 26b, the second seal member 56 is formed so as to surround the coolant supply passage 42a, the coolant discharge passage 42b, and the coolant flow field 50 for preventing leakage of the coolant.

As shown in FIG. 2, the end power generation cell 12a includes first and second outer separators 60a, 60b sandwiching the membrane electrode assembly 22, and the end power generation cell 12b includes first and second outer separators 62a, 62b sandwiching the membrane electrode assembly 22. Constituent elements of the end power generation cells 12a, 12b, which are identical to those of the other power generation cells 12, are labeled with the same reference numerals, and descriptions thereof shall be omitted.

The first outer separator 62a and the second outer separator 60b have a structure similar to the structure of the first metal separator 24. The first outer separator 60a and the second outer separator 62b have a structure similar to the structure of the second metal separator 26.

The first outer separator 60a of the end power generation cell 12a contacts the terminal plate 16a, and the first outer separator 62a of the end power generation cell 12b contacts the terminal plate 16b. In comparison with the first and second metal separators 24, 26 of the other power generation cells 12 provided inwardly of the end power generation cells 12a, 12b, the first outer separators 60a, 62a are more highly hydrophilic.

For effecting a hydrophilic treatment, for example, a solution is used, which includes a mixture of a hydrophilic material and a liquid medium. The first outer separators 62a, 60a are fabricated by applying the solution to the first and second metal separators 24, 26. Further, it should be appreciated that various types of conventional hydrophilic treatments can be adopted.

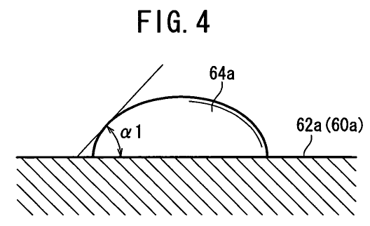

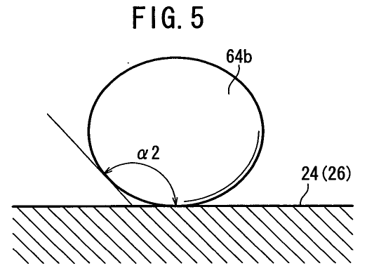

Hydrophilic characteristics can be evaluated by the contact angle between water droplets and the material surface. For example, as shown in FIG. 4, the contact angle al between the surface of the first outer separators 62a, 60a and a water droplet 64a is 90° or less. On the other hand, as shown in FIG. 5, for example, the contact angle a2 between the surface of the first and second metal separators 24, 26 and a water droplet 64b is greater than 90°.

The second outer separators 60b, 62b may also be more highly hydrophilic in comparison with the first and second metal separators 24, 26 of the power generation cell 12. Further, the hydrophilic characteristics of the second outer separators 60b, 62b may be equal to the hydrophilic characteristics of the first outer separators 60a, 62a. Or, in a preferred embodiment of the present invention, the first outer separators 60a, 62a are more highly hydrophilic in comparison with the second outer separators 60b, 62b.

Next, operation of the fuel cell stack 10 having the above structure shall be described.

As shown in FIG. 1, an oxygen-containing gas is supplied to the oxygen-containing gas supply passage 40a from the end plate 20a of the fuel cell stack 10. A fuel gas such as a hydrogen-containing gas is supplied to the fuel gas supply passage 44a. Further, a coolant, such as purified water or ethylene glycol, is supplied to the coolant supply passage 42a.

As shown in FIG. 3, the oxygen-containing gas flows from the oxygen-containing gas supply passage 40a into the oxygen-containing gas flow field 46 of the first metal separator 24. In the oxygen-containing gas flow field 46, oxygen-containing gas is distributed through the oxygen-containing gas flow grooves 46a. Therefore, the oxygen-containing gas flows through the oxygen-containing gas flow grooves 46a and moves along the cathode 32 of the membrane electrode assembly 22, thereby inducing an electrochemical reaction at the cathode 32.

On the other hand, the fuel gas flows from the fuel gas supply passage 44a into the fuel gas flow field 48 of the second metal separator 26. In the fuel gas flow field 48, fuel gas is distributed through the fuel gas flow grooves 48a. Furthermore, the fuel gas flows through the fuel gas flow grooves 48a and moves along the anode 30 of the membrane electrode assembly 22, thereby inducing an electrochemical reaction at the anode 30.

Thus, in each of the membrane electrode assemblies 22, the oxygen-containing gas supplied to the cathode 32, and the fuel gas supplied to the anode 30 are consumed in electrochemical reactions at catalyst layers of the cathode 32 and the anode 30, thereby generating electricity.

After the oxygen in the oxygen-containing gas is consumed at the cathode 32, the oxygen-containing gas is discharged into the oxygen-containing gas discharge passage 40b. Likewise, after the fuel gas is consumed at the anode 30, the fuel gas is discharged into the fuel gas discharge passage 44b.

The coolant flows from the coolant supply passage 42a into the coolant flow field 50 between the first and second metal separators 24, 26. In the coolant flow field 50, the coolant flows in the direction indicated by the arrow B. After the coolant has been used for cooling the entire power generation surface of the membrane electrode assembly 22, the coolant is discharged into the coolant discharge passage 42b.

As shown in FIG. 2, the fuel cell stack 10 includes the end power generation cells 12a, 12b, located at opposite ends of the stacked body 14 in the stacking direction. The end power generation cell 12a includes the first outer separator 60a, which contacts the terminal plate 16b. The end power generation cell 12b includes the first outer separator 62a, which contacts the terminal plate 16b.

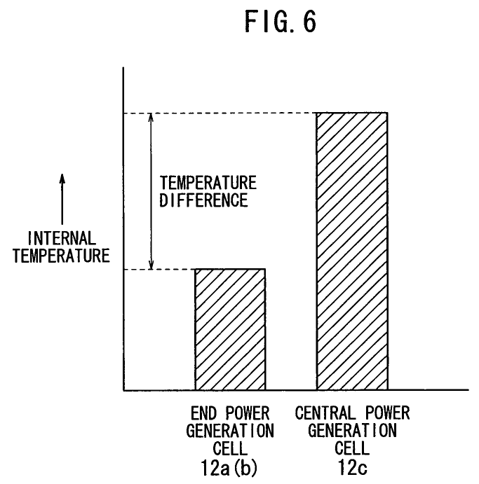

In the fuel cell stack 10, due to external heat radiation to the outside, in particular, the temperature in the end power generation cells 12a, 12b decreases more easily in comparison with the other power generation cells 12. As a result, the amount of heat radiation from a central power generation cell 12c, positioned at the center of the stacked body 14 in the stacking direction, is different from the amount of heat radiation from the end power generation cells 12a, 12b. Therefore, a large difference in internal temperature is likely to occur in the fuel cell stack 10 (see FIG. 6).

In the embodiment of the present invention, a hydrophilic treatment is applied to the first outer separator 60a of the end power generation cell 12a and the first outer separator 62a of the end power generation cell 12b. Thus, the first outer separators 60a, 62a are made more highly hydrophilic in comparison with the first and second metal separators 24, 26 of the other power generation cells 12.

Thus, in the end power generation cells 12a, 12b, where water condensation occurs more easily in comparison with the central power generation cell 12c, an improvement is achieved in that water is discharged more efficiently from the first outer separators 60a and 62a. Consequently, the fuel gas and the oxygen-containing gas flow smoothly. Accordingly, with a simple and economical structure, it is possible for the flow rates of the fuel gas and the oxygen-containing gas flowing through the end power generation cells 12a, 12b to be set equally to the flow rates of the fuel gas and the oxygen-containing gas flowing through the other power generation cells 12 (including the central power generation cell 12c). Thus, it is possible to reliably improve overall power generation efficiency of the fuel cell stack 10.

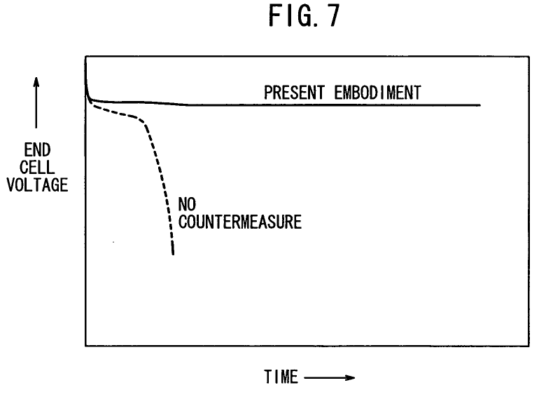

Specifically, as shown in FIG. 7, in end power generation cells 12a, 12b which are not subjected to hydrophilic treatment (i.e., without any countermeasure), the fuel gas and/or the oxygen-containing gas does not flow smoothly, due to retention of condensed water in the end power generation cells 12a, 12b, and the end cell voltage decreases significantly. In contrast, in the embodiment of the present invention in which a hydrophilic treatment is applied to the end power generation cells 12a, 12b, water discharging efficiency is improved, and the fuel gas and the oxygen-containing gas flow smoothly. Consequently, the end cell voltage can be suitably maintained.

In the embodiment of the present invention, a hydrophilic treatment is applied to the first outer separators 60a, 62a of the end power generation cells 12a, 12b. Further, as necessary, a hydrophilic treatment may also be applied to the second outer separators 60b, 62b. However, the present invention is not limited in this respect. For example, a hydrophilic treatment may also be applied to predetermined power generation cells 12 such that the power generation cells become more highly hydrophilic, from the central power generation cell 12c to the end power generation cells 12a, 12b, in a stepwise or continuous manner.

While the invention has been particularly shown and described with reference to a preferred embodiment, it shall be understood that variations and modifications can be made thereto by those skilled in the art, without departing from the spirit and scope of the invention as set forth in the appended claims.

What is claimed is:

1. A fuel cell stack formed by stacking a plurality of power generation cells in a stacking direction, said power generation cells each including an electrolyte electrode assembly and separators sandwiching said electrolyte electrode assembly therebetween, said electrolyte electrode assembly including a pair of electrodes and an electrolyte interposed between said electrodes, said fuel cell stack further comprising:
end power generation cells provided at opposite ends of said power generation cells in the stacking direction,
wherein outer separators of said end power generation cells are more highly hydrophilic in comparison with inner separators of said power generation cells provided inwardly of at least said end power generation cells.

2. A fuel cell stack according to claim 1, wherein a contact angle of water in said outer separators-is smaller than a contact angle of water in said inner separators.

3. A fuel cell stack according to claim 1, wherein said outer separators include a first outer separator provided at an end in the stacking direction, and a second outer separator provided inwardly of said first outer separator in the stacking direction, and
wherein said first outer separator is more highly hydrophilic than said second outer separator.

4. A fuel cell stack according to claim 3, wherein said first outer separator contacts a terminal plate.

5. A fuel cell stack according to claim 1, wherein a contact angle of water in said outer separators is 90° or less.

6. A fuel cell stack according to claim 1, wherein said outer separators and said inner separators are metal separators.

7. A fuel cell stack according to claim 1, wherein said electrolyte is a solid polymer electrolyte membrane.
